(19) United States
(12) Patent Application Publication
(10) Pub. No.: US 2018/0067515 A1
(43) Pub. Date: Mar. 8, 2018

(54) SEGREGATED TEST MODE CLOCK GATING CIRCUITS IN A CLOCK DISTRIBUTION NETWORK OF A CIRCUIT FOR CONTROLLING POWER CONSUMPTION DURING TESTING

(71) Applicant: QUALCOMM Incorporated, San Diego, CA (US)

(72) Inventors: Kunal Jain, Bangalore (IN); Moitrayee Ghosh, Bangalore (IN); Anand Bhat, Bangalore (IN); Joseph Fang, San Diego, CA (US)

(21) Appl. No.: 15/255,329

(22) Filed: Sep. 2, 2016

(51) Int. Cl. G06F 1/12

(52) U.S. Cl. CPC G06F 1/12

(57) ABSTRACT

Segregated test mode clock gating circuits in a clock distribution network of a circuit for controlling power consumption during testing is provided. To reduce power consumption and current-resistance (IR) drop during testing of a circuit, existing clock gating circuits (e.g., clock gating cells (CGCs)) that control the functional mode of circuit blocks in the circuit are additionally test mode gated for hierarchical testing of the circuit. To avoid the need to gate every CGC in the clock distribution network, only certain segregated clock gating circuits in the clock distribution network may be selected for test mode clock gating according to desired testing hierarchy of the circuit. Test mode clock gating of only certain segregated clock gating circuits in a circuit can reduce the number of test gating circuits providing test mode clock gating to mitigate power consumption and area needed for providing selective testing of circuit blocks in the circuit.

### BACKGROUND

### I. Field of the Disclosure

The technology of the disclosure relates generally to circuit testing, and more particularly to limiting circuit power consumption during testing to limit current-resistance (IR) drop during testing.

### II. Background

Power networks that provide power to circuits are designed for functional activity of the powered circuit. When a circuit is tested, power consumption is typically higher under test than when the circuit operates according to its normal functionality. This is because in test mode, switching activity typically occurs throughout the entire design in a circuit as circuit blocks in the circuit are activated. On the other hand, switching activity in a functional mode of the circuit is dependent on the function or operation being performed. Most circuit functions do not involve switching activity of circuit blocks throughout the entire design of the circuit. Thus, power consumption resulting from switching activity during normal functional modes does not provide the worst case power consumption that may be provided during a test mode when switching activity occurs throughout the entire design in a circuit. For these reasons, power consumption during test and functional modes of a circuit is often very different.

Higher test power consumption during testing of a circuit can cause several issues. For example, high power consumption in a circuit during test can cause high instantaneous current peaks that cause significant current-resistance (IR) drop in the power distribution circuitry, leading to random failures and yield fallout. IR-drop refers to the amount of decrease in power rail voltage and/or the amount of increase in ground rail voltage due to the resistance of the devices coupled between the power or ground rail and a node of interest in the circuit under test. It is common practice to specify a maximum per-rail static voltage drop tolerable during the initial design phase of the circuit. The larger the maximum tolerable per-rail static voltage drop, the worse the speed performance of the circuit. Also, higher power consumption in a circuit during test can limit the shift frequency that can be supported in various test modes of the circuit. A circuit which passes a slow speed scan test at nominal voltage or even minimum threshold voltage conditions (e.g., nominal voltage −10%) might fail a scan test where either the capture frequency is raised, the supply voltage is lowered, or both. This degradation in circuit test performance worsens as the frequency of the test increases. Similarly, the lower the supply voltage, the worse the circuit test performance. Thus, because of these test mode failures, a circuit that functionally operates according to specifications might be binned as a defective device solely because of failures caused by higher power consumption of the circuit during testing.

To overcome higher yield fallout during circuit test, a general method used is to test a circuit higher than a specified voltage. Testing a circuit using a higher voltage than the specification of the circuit results in under-testing those parts of the circuit which do not have IR-drop, thus causing test escapes. In other words, testing a circuit using a higher voltage than the specification of the circuit to compensate for higher IR-drop can mean under-testing components, which leads to higher defective parts per million (DPPM) rate or customer returns. Thus, there is a need to contain the test mode IR-drop in a tested circuit to limit the risk of yield fallout as well as test escapes. In response, many circuit manufacturers are opting for structural at-speed circuit testing, such as scan-based transition fault or path delay fault testing.

These approaches of limiting IR-drop during circuit testing may be approached by generating low toggle automatic test pattern generation (ATPG) patterns that limit overall switching activity in the circuit. For example, FIG. 1 is a schematic diagram of an exemplary tested circuit in the form of a central processing unit (CPU) 100 that can be tested during ATPG patterns. As shown in FIG. 1, the CPU 100 employs multiple processor cores. For example, the CPU 100 in FIG. 1 includes a parent processor core 102P and multiple child processor cores 102C(1)-102C(N) for multi-threaded operations. To facilitate hierarchical testing of the child processor cores 102C(1)-102C(N) separately as a way to limit IR-drop, each child processor core 102C(1)-102C(N) is divided by respective bounding circuits 104(1)-104(N) and core circuits 106(1)-106(N). For example, the bounding circuits 104(1)-104(N) can include circuits for interfacing the respective child processor cores 102C(1)-102C(N) with other processor-based circuits, such as local cache memory, communications buses, etc., and through respective circuit interfaces 108(1)-108(N) to the parent processor core 102P. The core circuits 106(1)-106(N) contain circuits for reading instructions and performing computational work based on execution of such instructions. A clock signal 110 from a clock distribution network 112 (shown in dashed lines in FIG. 1) is provided to clock gating cells (CGCs) (not shown) that gate (i.e., control) distribution of the clock signal 110 to both the respective bounding circuits 104(1)-104(N) and core circuits 106(1)-106(N) of the child processor cores 102C(1)-102C(N). However, when a core circuit 106(1)-106(N) of a particular child processor core 102C(1)-102C(N) is under test, the other non-tested child processor cores 102C(1)-102C(N) may also be active, because CGCs that gate the clock signal 110 to the tested child processor core 102C(1)-102C(N) also gate its respective bounding circuits 104(1)-104(N). The activity of the bounding circuits 104(1)-104(N) of the child processor core 102C(1)-102C(N) under test can cause toggling activity to occur in the other non-tested child processor cores 102C(1)-102C(N), thus still leading to significant IR-drop during testing.

Further, testing of the CPU 100 based on use of ATPG patterns leads to higher pattern count, and thereby higher test time and test cost. These costs are incurred in both the engineering time to develop the test patterns as well as the cost of the equipment to apply them. Alternatively, blocking gates could be added to every flip-flop output in the bounding circuits 104(1)-104(N) and the core circuits 106(1)-106(N) of the CPU 100 to limit toggle activity during testing. However, this leads to increased die area of the CPU 100, which may not be desired.

### SUMMARY OF THE DISCLOSURE

Aspects of the present disclosure involve segregated tested mode clock gating circuits in a clock distribution network of a circuit for controlling power consumption during testing. In aspects disclosed herein, a circuit is provided that includes synchronous circuit blocks and clock distribution networks for distributing a clock signal to control the state of the synchronous circuit blocks. To conserve dynamic power consumed by a clock distribution network, clock gating circuits are provided in various locations in the clock distribution network to control distribution of the clock signal to particular, assigned synchronous circuit blocks. For example, the clock gating circuits may be or include clock gating cells (CGCs). The clock gating circuits are configured to selectively couple and decouple the clock signal from their assigned synchronous circuit blocks when these synchronous circuit blocks do not need to function during functional modes. To also reduce power consumption and current-resistance (IR) drop during testing of the circuit, these existing clock gating circuits that control the functional mode of the circuit blocks in the circuit can additionally be test mode gated for hierarchal testing of the circuit. Thus, the functional clock distribution paths of the clock signal in the circuit may not be altered during testing of the circuit. To avoid the need to gate every CGC in the clock distribution network, only certain segregated clock gating circuits in the clock distribution network may be selected for test mode clock gating according to the desired testing hierarchy of the circuit. Circuit blocks that are directly or indirectly driven by a clock signal from a given clock gating circuit will be selectively enabled and disabled based on clock gating of the clock gating circuit. Thus for example, segregation of clock gating circuits for test mode clock gating may be based on identifying the highest level CGC that directly or indirectly controls clock distribution to the circuit blocks desired to be tested together. Test mode clock gating of only certain segregated clock gating circuits in a circuit can reduce the number of test gating circuits providing test mode clock gating to mitigate the power consumption and area needed for providing selective testing of circuit blocks of the circuit.

In this regard, in one exemplary aspect, a clock distribution network for distributing a clock signal to circuit blocks in a circuit is provided. The clock distribution network comprises a root node configured to receive a clock signal from a clock source. The clock distribution network also comprises a plurality of clock distribution paths coupled to the root node, each clock distribution path among the plurality of clock distribution paths configured to receive the clock signal. Each clock distribution path among the plurality of clock distribution paths comprises a plurality of clock gating circuits. The plurality of clock gating circuits comprises one or more functional clock gating circuits, wherein each functional clock gating circuit among the one or more functional clock gating circuits comprises a functional clock input configured to receive the clock signal, a functional clock output configured to receive the clock signal from the functional clock input, and a functional clock enable input configured to receive a clock enable signal. The functional clock gating circuit is configured to control distribution of the clock signal from the functional clock input to the functional clock output based on the clock enable signal being in a clock enable state. The plurality of clock gating circuits also comprises one or more test mode clock gating circuits segregated from the one or more functional clock gating circuits. Each test mode clock gating circuit among the one or more test mode clock gating circuits comprises a test clock input configured to receive the clock signal, a test clock output configured to receive the clock signal from the test clock input, and a test mode clock enable input configured to receive a test mode enable signal. The test mode clock gating circuit is configured to control distribution of the clock signal from the test clock input to the test clock output based on the clock enable signal being in the clock enable state and the test mode enable signal being in a test mode enable state.

In another exemplary aspect, a clock distribution network for distributing a clock signal to circuit blocks in a circuit is provided. The clock distribution network comprises a means for receiving a clock signal from a clock source. The clock distribution network also comprises a plurality of means for distributing the clock signal coupled to the means for receiving the clock signal from the clock source. Each of the plurality of means for distributing the clock signal is configured to receive the clock signal. Each means for distributing the clock signal among the plurality of means for distributing the clock signal comprises a plurality of means for gating the clock signal comprising one or more means for functionally gating the clock signal, each comprising a functional clock input means for receiving the clock signal, a functional clock output means for receiving the clock signal from the functional clock input means, a means for receiving a clock enable signal, and a means for controlling distribution of the clock signal from the functional clock input means to the functional clock output means based on the clock enable signal being in a clock enable state. The plurality of means for gating the clock signal also comprises one or more means for test mode clock gating the clock signal segregated from the one or more means for functionally gating the clock signal, the one or more means for test mode gating the clock signal each comprising a test clock input means for receiving the clock signal, a test clock output means for receiving the clock signal from the test clock input means, a means for receiving the clock enable signal, a means for receiving a test mode enable signal, and a means for controlling distribution of the clock signal from the test clock input means to the test clock output means based on the clock enable signal being in the clock enable state and the test mode enable signal being in a test mode enable state.

In another exemplary aspect, a method of testing a circuit is provided. The method comprises receiving a clock signal from a clock source at a root node. The method also comprises receiving the clock signal in a plurality of clock distribution paths coupled to the root node, each clock distribution path among the plurality of clock distribution paths comprising a plurality of clock gating circuits comprising one or more functional clock gating circuits and one or more test mode clock gating circuits segregated from the one or more functional clock gating circuits. The method also comprises, for each of the one or more functional clock gating circuits, receiving the clock signal, receiving a clock enable signal, and controlling distribution of the clock signal based on the clock enable signal being in a clock enable state. The method also comprises, for each of the one or more test mode clock gating circuits, receiving the clock signal, receiving the clock enable signal, receiving a test mode enable signal, and controlling distribution of the clock signal based on the clock enable signal being in the clock enable state and the test mode enable signal being in a test mode enable state.

In another exemplary aspect, a central processing system (CPU) is provided. The CPU comprises a clock distribution network. The clock distribution network comprises a root node configured to receive a clock signal from a clock source. The clock distribution network also comprises at least one bounding circuit clock distribution path coupled to the root node and configured to receive the clock signal and distribute the clock signal to at least one bounding circuit. The clock distribution network also comprises at least one core circuit clock distribution path coupled to the root node and configured to receive the clock signal and distribute the clock signal to at least one core circuit block. The clock distribution network also comprises a plurality of clock gating circuits comprising one or more functional clock gating circuits and one or more test mode clock gating circuits segregated from the one or more functional clock gating circuits. The at least one bounding circuit clock distribution path comprises one or more functional clock gating circuits and one or more test mode clock gating circuits segregated from the one or more functional clock gating circuits. The at least one core circuit clock distribution path comprises one or more functional clock gating circuits and one or more test mode clock gating circuits segregated from the one or more functional clock gating circuits. Each functional clock gating circuit among the one or more functional clock gating circuits comprises a functional clock input configured to receive the clock signal, a functional clock output configured to receive the clock signal from the functional clock input, and a functional clock enable input configured to receive a clock enable signal. The functional clock gating circuit is configured to control distribution of the clock signal from the functional clock input to the functional clock output based on the clock enable signal being in a clock enable state. Each test mode clock gating circuit of the one or more test mode clock gating circuits is segregated from the one or more functional clock gating circuits. Each test mode clock gating circuit comprises a test clock input configured to receive the clock signal, a test clock output configured to receive the clock signal from the test clock input, and a test mode clock enable input configured to receive a test mode enable signal. The test mode clock gating circuit is configured to control distribution of the clock signal from the test clock input to the test clock output based on the clock enable signal being in the clock enable state and the test mode enable signal being in a test mode enable state. The CPU also comprises a plurality of processor cores. Each processor core among the plurality of processor cores comprises one or more core circuits configured to receive the clock signal from the at least one core circuit clock distribution path and perform synchronous operations in response to the clock signal. Each processor core among the plurality of processor cores also comprises one or more bounding circuits interfaced to the core circuit block, the bounding circuit configured to receive the clock signal from the at least one bounding circuit clock distribution path and perform synchronous operations in response to the clock signal.

### BRIEF DESCRIPTION OF THE FIGURES

FIG. 1 is a schematic diagram of a central processing unit (CPU) employing multiple processor cores each having divided bounding circuits and core circuits for hierarchical testing;

FIG. 2A is a schematic diagram of an exemplary CPU employing multiple processor cores each having divided bounding circuits and core circuits for hierarchical testing, and further including segregated test mode clock gating circuits in a clock distribution network for selectively controlling clock signal distribution to circuit blocks during testing;

FIG. 2B is a schematic diagram illustrating a clock distribution network in a processor core in the CPU in FIG. 2A and clock gating circuits employed in the clock distribution network for functional clock gating of the bounding circuits and core circuits in the processor core;

FIG. 3 is a schematic diagram of exemplary segregated test mode clock gating circuits among the clock gating circuits in the clock distribution network in the CPU in FIG. 2B for facilitating separate activation of the bounding circuits and core circuits in the processor core during testing;

FIG. 4A is a schematic diagram illustrating an exemplary test mode enabling and disabling of segregated test mode clock gating circuits in the clock distribution network in the processor core in the CPU in FIGS. 2A and 2B during a shift mode of the processor core;

FIG. 4B is a schematic diagram illustrating an exemplary test mode enabling and disabling of segregated test mode clock gating circuits in the clock distribution network in the processor core in the CPU in FIGS. 2A and 2B during a capture mode of the processor core;

FIG. 5 is a schematic diagram illustrating the test mode disabling of all the segregated test mode clock gating circuits in the clock distribution network in the processor core in the CPU in FIGS. 2A and 2B during a blockoff mode of the processor core;

FIG. 6 is a table illustrating exemplary functional and test mode clock gating scenarios of the clock gating circuits that can be employed in the clock distribution network in FIG. 3;

FIG. 7A is a schematic diagram of an exemplary clock gating circuit provided in the form of a clock gating cell (CGC) that includes a negative edge-triggered latch to synchronize an enable signal to a clock signal;

FIG. 7B is a schematic diagram of another exemplary clock gating circuit provided in the form of a CGC that includes a positive edge-triggered latch to synchronize an enable signal to a clock signal;

FIG. 8A is a schematic diagram of an exemplary clock gating circuit that can be provided in a clock distribution network, such as the clock distribution network in FIG. 3 for example, wherein the clock gating circuit is configured to be functionally clock enabled during a functional mode and test mode clock enabled during a test mode;

FIG. 8B is a schematic diagram of another exemplary clock gating circuit that can be provided in a clock distribution network, such as the clock distribution network in FIG. 3 for example, wherein the clock gating circuit is configured to be functionally clock enabled during a functional mode and test mode clock enabled during a test mode based on a programmed toggle test pattern;

FIG. 9 is a flowchart illustrating an exemplary process of test mode clock gating segregated test mode clock gating circuits in a circuit to provide for hierarchical testing of circuit blocks in the circuit; and

FIG. 10 is a block diagram of an exemplary processor-based system that includes a CPU that includes one or more processor cores, such as the CPU in FIGS. 2A and 2B as a non-limiting example, and includes a clock distribution network for functional clock gating and test mode clock gating of circuit blocks in the one or more processor cores, including but not limited to the clock distribution network in FIG. 3 as a non-limiting example.

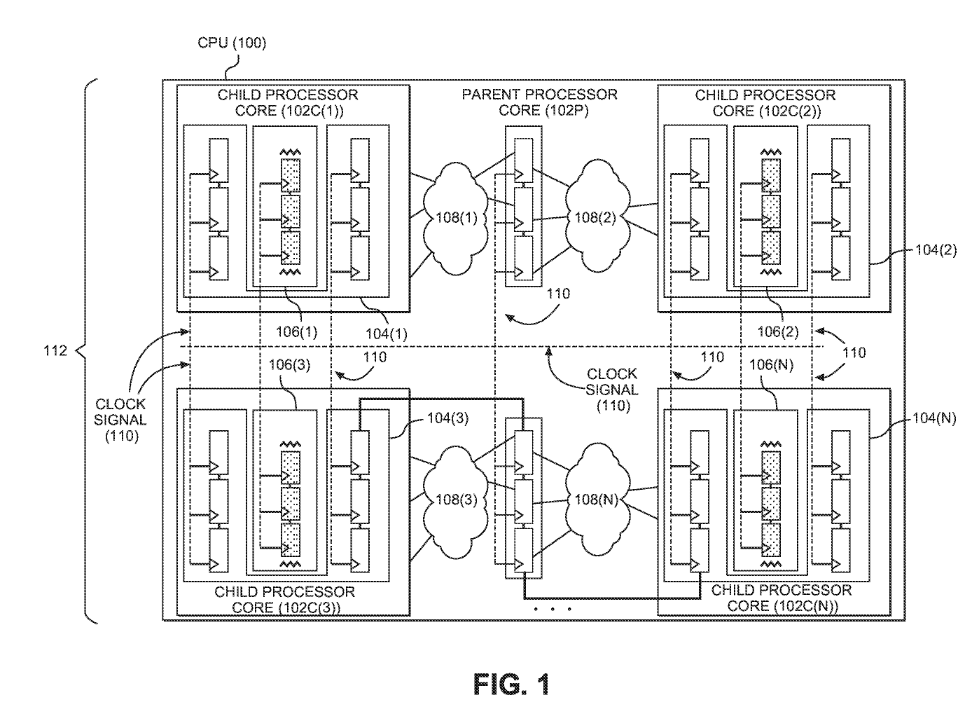

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects of the present disclosure involve segregated tested mode clock gating circuits in a clock distribution network of a circuit for controlling power consumption during testing. In aspects disclosed herein, a circuit is provided that includes synchronous circuit blocks and clock distribution networks for distributing a clock signal to control the state of the synchronous circuit blocks. To conserve dynamic power consumed by a clock distribution network, clock gating circuits are provided in various locations in the clock distribution network to control distribution of the clock signal to particular, assigned synchronous circuit blocks. For example, the clock gating circuits may be or include clock gating cells (CGCs). The clock gating circuits are configured to selectively couple and decouple the clock signal from their assigned synchronous circuit blocks when these synchronous circuit blocks do not need to function during functional modes. To also reduce power consumption and current-resistance (IR) drop during testing of the circuit, these existing clock gating circuits that control the functional mode of the circuit blocks in the circuit can additionally be test mode gated for hierarchal testing of the circuit. Thus, the functional clock distribution paths of the clock signal in the circuit may not be altered during testing of the circuit. To avoid the need to gate every CGC in the clock distribution network, only certain segregated clock gating circuits in the clock distribution network may be selected for test mode clock gating according to the desired testing hierarchy of the circuit. Circuit blocks that are directly or indirectly driven by a clock signal from a given clock gating circuit will be selectively enabled and disabled based on clock gating of the clock gating circuit. Thus for example, segregation of clock gating circuits for test mode clock gating may be based on identifying the highest level CGC that directly or indirectly controls clock distribution to the circuit blocks desired to be tested together. Test mode clock gating of only certain segregated clock gating circuits in a circuit can reduce the number of test gating circuits providing test mode clock gating to mitigate the power consumption and area needed for providing selective testing of circuit blocks of the circuit.

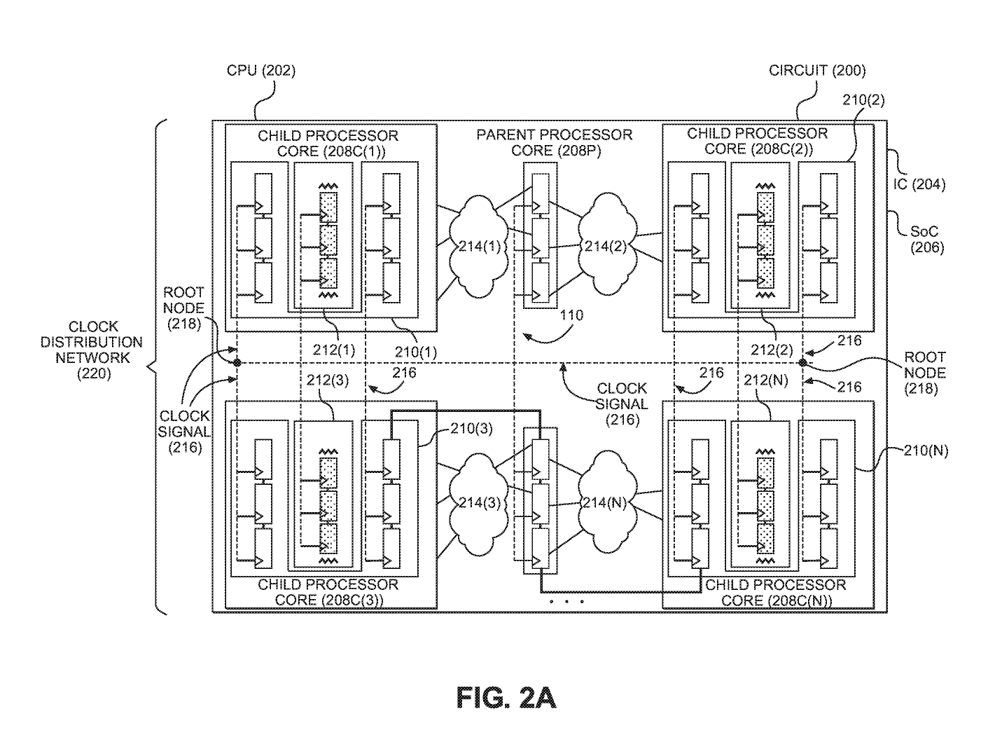

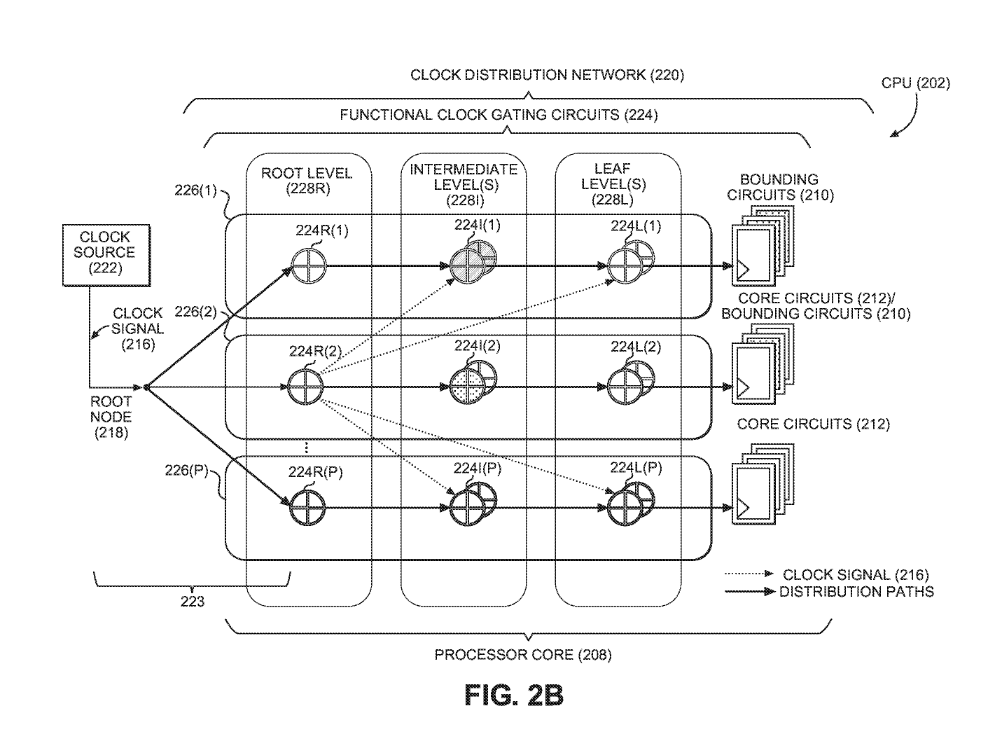

In this regard, FIG. 2A is a schematic diagram of a circuit 200 in the form of a CPU 202 that includes segregated test mode clock gating circuits among a plurality of clock gating circuits in a clock distribution network for selectively controlling clock signal distribution to synchronous circuit blocks in the CPU 202 during testing. For example, the CPU 202 may be provided as or in an integrated circuit (IC) 204 in a chip. The CPU 202 may also be provided as or in a system-on-a-chip (SoC) 206. As will be discussed in more detail below, the segregated test mode clock gating circuits may also be functionally gated during functional operational modes to conserve dynamic power when the gated circuit blocks are not required to be operational.

As shown in FIG. 2A, the CPU 202 includes a parent processor core 208P and multiple child processor cores 208C(1)-208(N) for multi-threaded operations. In this example of the CPU 202, to facilitate hierarchical testing of the child processor cores 208C(1)-208C(N) separately as a way to limit IR-drop, each child processor core 208C(1)-208C(N) is divided by respective bounding circuits 210(1)-210(N) and core circuits 212(1)-212(N). For example, the bounding circuits 210(1)-210(N) can include circuits for interfacing the respective child processor cores 208C(1)-208(N) with other processor-based circuits, such as local cache memory, communications buses, etc., and through respective circuit interfaces 214(1)-214(N) to the parent processor core 208P. The core circuits 212(1)-212(N) contain circuits for reading instructions and performing computational work based on execution of such instructions. A clock signal 216 from a root node 218 in a clock distribution network 220 (shown in dashed lines in FIG. 2) is provided to the bounding circuits 210(1)-210(N) and the core circuits 212(1)-212(N) in the CPU 202 for synchronous operation.

For example, FIG. 2B illustrates the clock distribution network 220 in a single processor core 208 which can be any of the processor cores 208P, 208C(1)-208C(N) in the CPU 202 in FIG. 2A. Note that the clock distribution network 220 illustrated in FIG. 2B is only the portion the clock distribution network 220 in the single shown processor core 208. However, the discussion of the clock distribution network 220 in FIG. 2B is applicable to the CPU 202 as a whole and its other processor cores 208P, 208C(1)-208C(N). The clock signal 216 is provided to functional clock gating circuits 224 in the clock distribution network 220 coupled between the root node 218 and the bounding circuits 210 and the core circuits 212. The functional clock gating circuits 224 gate the distribution of the clock signal 216 to the bounding circuits 210 and the core circuits 212 during functional operational modes to conserve dynamic power. For example, it may not be necessary for all bounding circuits 210 and core circuits 212 to be active at the same time during certain operational modes of the CPU 202. Further, if the processor core 208 does not need to be active during a particular functional mode, the clock signal 216 can be gated to not be distributed to any of the bounding circuits 210 and the core circuits 212 in the processor core 208.

As will be discussed in more detail below, to also control which bounding circuits 210 and which core circuits 212 are activated during testing to conserve power and to limit IR-drop during testing, certain segregated clock gating circuits among the functional clock gating circuits 224 in the clock distribution network 220 are test mode gated. This is opposed to requiring test mode clock gating all the functional clock gating circuits 224 in the clock distribution network 220. For example, segregation of the functional clock gating circuits 224 for test mode clock gating may be based on identifying the highest level functional clock gating circuit 224 that directly or indirectly controls clock signal 216 distribution to the bounding circuits 210 and the core circuits 212 desired to be tested together. Test mode clock gating of only certain segregated functional clock gating circuits 224 in the clock distribution network 220 can reduce the number of test gating circuits in the CPU 202 to mitigate the power consumption and area needed for providing selective testing of the bounding circuits 210 and the core circuits 212 in the processor core 208.

In this regard, as shown in FIG. 2B, the clock distribution network 220 includes the root node 218 configured to receive the clock signal 216 from a clock source 222 in a root clock distribution path 223. The clock source 222 may be internal or external to the CPU 202. The clock distribution network 220 includes a plurality of clock distribution paths 226(1)-226(P) coupled to the root node 218 such that each clock distribution path 226(1)-226(P) receives the clock signal 216. In this example, the clock distribution paths 226(1)-226(P) include a bounding circuit clock distribution path 226(1), a core circuit clock distribution path 226(P), and a common circuit clock distribution path 226(2). The bounding circuit clock distribution path 226(1) distributes the clock signal 216 to only bounding circuits 210 in the processor core 208 in this example. The core circuit clock distribution path 226(P) distributes the clock signal 216 to only core circuits 212 in the processor core 208 in this example. The common circuit clock distribution path 226(2) distributes the clock signal 216 to both bounding circuits 210 and core circuits 212 in the processor core 208 in this example. Each clock distribution path 226(1)-226(P) contains functional clock gating circuits 224 that control the distribution of the clock signal 216 to the respective bounding circuits 210 and/or core circuits 212. As will be discussed in more detail below, the functional clock gating circuits 224 may be CGCs as a non-limiting example.

With continuing reference to FIG. 2B, in this example, to control distribution of the clock signal 216 in the bounding circuit clock distribution path 226(1), the bounding circuit clock distribution path 226(1) includes a root functional clock gating circuit 224R(1) provided in a root level 228R of the bounding circuit clock distribution path 226(1) in the clock distribution network 220. An intermediate functional clock gating circuit 224I(1) is provided in an intermediate level(s) 228I of the bounding circuit clock distribution path 226(1) in the clock distribution network 220. A leaf functional clock gating circuit 224L(1) is provided in a leaf level(s) 228L of the bounding circuit clock distribution path 226(1) in the clock distribution network 220. The bounding circuits 210 are shown as being configured to receive the clock signal 216 from the leaf functional clock gating circuit 224L(1), but note that the bounding circuits 210 could also be configured to receive the clock signal 216 from an intermediate functional clock gating circuit 224I(1) or root functional clock gating circuit 224R(1). Providing the root functional clock gating circuit 224R(1), intermediate functional clock gating circuit 224I(1), and the leaf functional clock gating circuit 224L(1) allows the distribution of the clock signal 216 to be controlled at each of the root level 228R, intermediate level(s) 228I, and leaf level(s) 228L of the bounding circuit clock distribution path 226(1). For example, it may be desired to disable all operations of all circuits coupled to the bounding circuit clock distribution path 226(1) in a functional mode. In this regard, only the root functional clock gating circuit 224R(1) need prevent distribution of the clock signal 216 to the bounding circuit clock distribution path 226(1), which also prevents receipt of the clock signal 216 by the intermediate functional clock gating circuit 224R(1) and the leaf functional clock gating circuit 224L(1) in the bounding circuit clock distribution path 226(1), and any bounding circuits 210 configured to receive the clock signal 216 from such intermediate functional clock gating circuit 224I(1) and the leaf functional clock gating circuit 224L(1). However, by providing the intermediate functional clock gating circuit 224I(1) and the leaf functional clock gating circuit 224L(1) in the intermediate and leaf level(s) 228I, 228L, the distribution of the clock signal 216 can be selectively controlled at a more granular level to only certain bounding circuits 210 coupled to certain intermediate functional clock gating circuit 224I(1) and the leaf functional clock gating circuit 224L(1) without preventing distribution of the clock signal 216 in the entire bounding circuit clock distribution path 226(1).

Similarly, with continuing reference to FIG. 2B, in this example, to control distribution of the clock signal 216 in the core circuit clock distribution path 226(P), the core circuit clock distribution path 226(P) also includes a root functional clock gating circuit 224R(P) provided in a root level 228R of the core circuit clock distribution path 226(P) in the clock distribution network 220. An intermediate functional clock gating circuit 224I(P) is provided in an intermediate level(s) 228I of the core circuit clock distribution path 226(P) in the clock distribution network 220. A leaf functional clock gating circuit 224L(P) is provided in a leaf level(s) 228I of the core circuit clock distribution path 226(P) in the clock distribution network 220. The core circuits 212 are shown as being configured to receive the clock signal 216 from the leaf functional clock gating circuit 224L(P), but note that core circuits 212 could also be configured to receive the clock signal 216 from an intermediate functional clock gating circuit 224I(P) or the root functional clock gating circuit 224R(P). Providing the root functional clock gating circuit 224R(P), intermediate functional clock gating circuit 224I(P), and the leaf functional clock gating circuit 224L(P) allows the distribution of the clock signal 216 to be controlled at each of the root level 228R, intermediate level(s) 228I, and leaf level(s) 228L of the core circuit clock distribution path 226(P). For example, it may be desired to disable all operations of all circuits coupled to the core circuit clock distribution path 226(P) in a functional mode. In this regard, only the root functional clock gating circuit 224R(P) need prevent distribution of the clock signal 216 to the core circuit clock distribution path 226(P), which also prevents receipt of the clock signal 216 by the intermediate functional clock gating circuit 224R(P) and the leaf functional clock gating circuit 224L(P) in the core functional circuit clock distribution path 226(P), and any core circuits 212 configured to receive the clock signal 216 from such intermediate functional clock gating circuit 224R(P) and the leaf functional clock gating circuit 224L(P). However, by providing the intermediate functional clock gating circuit 224I(P) and the leaf functional clock gating circuit 224L(P) in the intermediate and leaf level(s) 228I, 228L, the distribution of the clock signal 216 can be selectively controlled at a more granular level to only certain core circuits 212 coupled to certain intermediate functional clock gating circuit 224I(P) and the leaf functional clock gating circuit 224L(P) without preventing distribution of the clock signal 216 in the entire core circuit clock distribution path 226(P).

Similarly, with continuing reference to FIG. 2B, in this example, to control distribution of the clock signal 216 in the common circuit clock distribution path 226(2), the common circuit clock distribution path 226(2) also includes a root functional clock gating circuit 224R(2) provided in a root level 228R of the common circuit clock distribution path 226(2) in the clock distribution network 220. An intermediate functional clock gating circuit 224I(2) is provided in an intermediate level(s) 228I of the common circuit clock distribution path 226(2) in the clock distribution network 220. A leaf functional clock gating circuit 224L(2) is provided in a leaf level(s) 228L of the common circuit clock distribution path 226(2) in the clock distribution network 220. Providing the root functional clock gating circuit 224R(2), intermediate functional clock gating circuit 224I(2), and the leaf functional clock gating circuit 224L(2) allows the distribution of the clock signal 216 to be controlled at each of the root level 228R, intermediate level(s) 228I, and leaf level(s) 228L of the common circuit clock distribution path 226(2) to selectively control clock signal 216 distribution to common bounding and core circuits 210, 212 provided in the common circuit clock distribution path 226(2).

With continuing reference to FIG. 2B, note that certain functional clock gating circuits 224 are provided in the multiple clock distribution paths 226(1)-226(P). For example, the intermediate functional clock gating circuit 224I(1) is in the bounding circuit clock distribution path 226(1) and the common circuit clock distribution path 226(2) by virtue of being configured to receive the clock signal 216 from the root functional clock gating circuit 224R(2). This configuration may be desired, for example, if it is desired for certain bounding circuits 210 to receive the clock signal 216 from the root functional clock gating circuit 224R(2) even if the clock signal 216 is not received from the root functional clock gating circuit 224R(1) in the bounding circuit clock distribution path 226(1). The exact configuration of coupling of the functional clock gating circuits 224 in the clock distribution paths 226(1)-226(P) is dependent on the hierarchical design for functional operation of the CPU 202.

It may be desired to also test the CPU 202 in FIG. 2A. It may be desired to test each processor core 208P, 208C(1)-208C(N) separately and/or different common bounding and core circuits 210, 212 within each processor core 208P, 208C(1)-208C(N) separately to limit power consumption and IR-drop during testing. Thus, in aspects disclosed herein, the functional clock gating circuits 224 in the clock distribution network 220 in FIG. 2B can be configured to also be test mode gated as test mode clock gating circuits to control distribution of the clock signal 216 by the functional clock gating circuits 224 during a test mode. This may be useful, because for example, when a particular child processor core 208C(1)-208C(N) is under test, such as child processor core 208 in FIG. 2B, the other non-tested child processor cores 208C(1)-208C(N) in the CPU 202 in FIG. 2A may also be active. This is because the functional clock gating circuits 224 that gates the clock signal 216 to the tested child processor core 208 in FIG. 2B may also gate its respective bounding circuits 210 in the other non-tested child processor cores 208C(1)-208C(N). The activity of the bounding circuits 210 of the processor core 208 under test can cause toggling activity to occur in the other non-tested child processor cores 208C(1)-208C(N), thus still leading to significant IR-drop in the CPU 202 during testing.

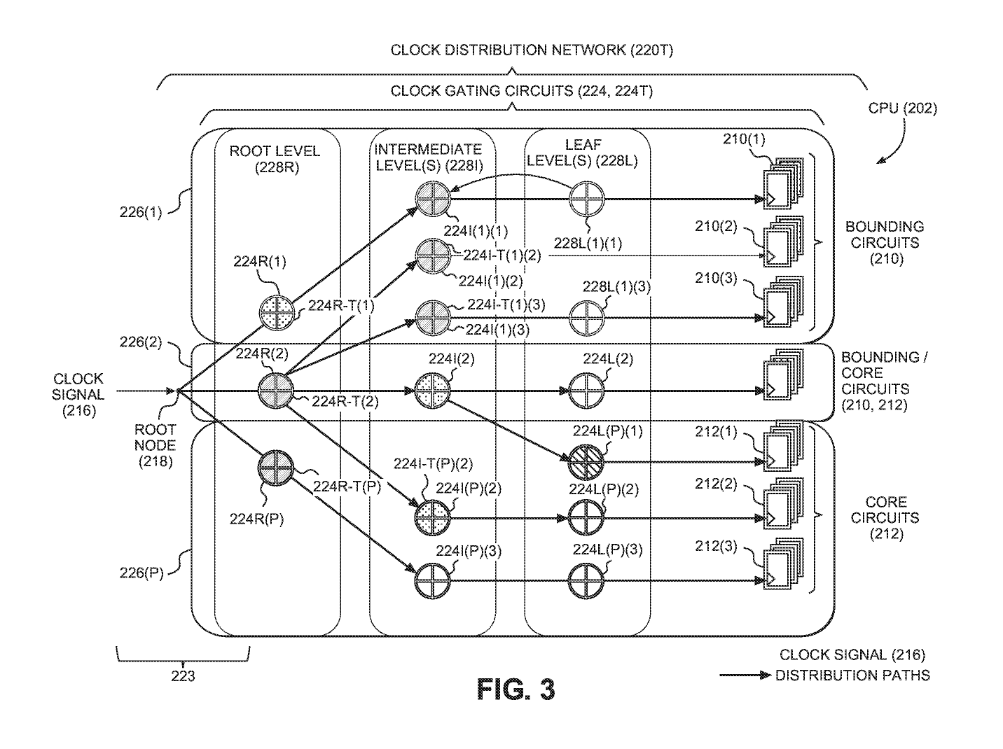

FIG. 3 is a schematic diagram of an alternative clock distribution network 220T that can be provided in the CPU 202 in FIG. 2A. Common components between the clock distribution network 220 in FIG. 2A and the clock distribution network 220T in FIG. 3 are shown with common element numbers, and thus will not be re-described. As shown in FIG. 3, certain functional clock gating circuits 224 are segregated and provided as test mode clock gating circuits 224T. A test mode clock gating circuit 224T is a clock gating circuit that is configured to control distribution of the clock signal 216 based on a functional operational mode or a test mode. Not every functional clock gating circuit 224 is provided as a test mode clock gating circuit 224T in this example. As will be discussed in more detail below, the test mode clock gating circuits 224T can be selectively controlled to distribute or not distribute the clock signal 216 based on a test mode. The test mode clock gating circuits 224T can also be selectively controlled to distribute or not distribute the clock signal 216 based on a functional operational mode. For example, segregation of the functional clock gating circuits 224 to provide the test mode clock gating circuits 224T may be based on identifying the highest level clock gating circuit that directly or indirectly controls clock signal 216 distribution to the common bounding and core circuits 210, 212 desired to be tested together. Test mode clock gating of only certain segregated functional clock gating circuits 224 can reduce the number of test mode clock gating circuits to mitigate the power consumption and area needed for providing selective testing of circuit blocks in the CPU 202.

With reference to the example clock distribution network 220T in FIG. 3, note that root level 228R includes root functional clock gating circuit 224R(1) in the bounding circuit clock distribution path 226(1), a root functional clock gating circuit 224R(2) in the common circuit clock distribution path 226(2), and a root functional clock gating circuit 224R(P) in the core circuit clock distribution path 226(P). Because it is desired to selectively distribute and not distribute the clock signal 216 through the entire bounding circuit clock distribution path 226(1) during certain test modes, the root functional clock gating circuit 224R(1) is segregated to be a root test mode clock gating circuit 224R-T(1). Similarly, because it is desired to be able to selectively distribute and not distribute the clock signal 216 throughout the entire common circuit clock distribution path 226(2) during certain test modes, the root functional clock gating circuit 224R(2) is also segregated to be a root test mode clock gating circuit 224R-T(2). Also similarly, because it is desired to be able to selectively distribute and not distribute the clock signal 216 throughout the entire core circuit clock distribution path 226(P) during certain test modes, the root functional clock gating circuit 224R(P) is also segregated to be a root test mode clock gating circuit 224R-T(P). Thus, the root test mode clock gating circuit 224R-T(1)-224R-T(P) being at the root level 228R act as block clock gating circuits that can block the clock signal 216 distribution to all downstream intermediate and leaf functional clock gating circuits 224I, 224L unless independently driven by another active clock signal 216 distribution source. Because the root functional clock gating circuit 224R(1)-224R(P) are the highest level clock gating circuits that control clock signal 216 distribution to their respective clock distribution paths 226(1)-226(P), these root functional clock gating circuit 224R(1)-224R(P) can be segregated as root test mode clock gating circuit 224R-T(1)-224R-T(P) without having to segregate other downstream intermediate and leaf functional clock gating circuit 224I, 224L in the intermediate and leaf level(s) 228I, 228L to be able to selectively test the bounding circuits 210 and the core circuits 212, without activity in one causing activity in the other, and vice versa.

With continuing reference to FIG. 3, in this example, the intermediate level(s) 228I includes three (3) intermediate functional clock gating circuit 224I(1)(1)-224I(1)(3) in the bounding circuit clock distribution path 226(1). The intermediate functional clock gating circuit 224I(1)(1) controls distribution of the clock signal 216 to an intermediate functional clock gating circuit 228L(1)(1) in the leaf level(s) 228L of the bounding circuit clock distribution path 226(1), which controls clock signal 216 distribution to bounding circuit 210(1). The intermediate functional clock gating circuit 224I(1)(2) controls distribution of the clock signal 216 directly to bounding circuit 210(2). The intermediate functional clock gating circuit 224I(1)(3) controls distribution of the clock signal 216 to a functional clock gating circuit 228L(1)(3) in the leaf level(s) 228L of the bounding circuit clock distribution path 226(1), which controls clock signal 216 distribution to bounding circuit 210(3). The intermediate level(s) 228I includes one (1) intermediate functional clock gating circuit 224I(2) in the common circuit clock distribution path 226(2). The intermediate functional clock gating circuit 224I(2) controls distribution of the clock signal 216 to a leaf functional clock gating circuit 228L(2) in the leaf level(s) 228L of the common circuit clock distribution path 226(2), which controls clock signal 216 distribution to common bounding and core circuits 210, 212. Note that the intermediate functional clock gating circuit 224I(P)(2) does not receive the clock signal 216 from the bounding circuit clock distribution path 226(1), but instead from the root functional clock gating circuit 224R(2) in the common circuit clock distribution path 226(2).

With continuing reference to FIG. 3, the intermediate level(s) 228I also include two (2) intermediate functional clock gating circuit 224I(P)(2)-224I(P)(3) in the core circuit clock distribution path 226(P). The intermediate functional clock gating circuit 224I(P)(3) controls distribution of the clock signal 216 to a leaf functional clock gating circuit 224L(P)(3) in the leaf level(s) 228L of the core circuit clock distribution path 226(P), which controls clock signal 216 distribution to core circuit 212(3). Note that the leaf functional clock gating circuit 224L(P)(1) in the leaf level(s) 228L does not receive the clock signal 216 from the core circuit clock distribution path 226(P), but instead from the intermediate functional clock gating circuit 224I(2) in the intermediate level(s) 228I of the common circuit clock distribution path 226(2). The intermediate functional clock gating circuit 224I(P)(1) controls clock signal 216 distribution to the core circuit 212(1). Also note that the intermediate functional clock gating circuit 224I(2) in the common circuit clock distribution path 226(2) controls distribution of the clock signal 216 to a leaf functional clock gating circuit 228L(P)(2) in the leaf level(s) 228L of the core circuit clock distribution path 226(P), which controls clock signal 216 distribution to core circuit 212(2).

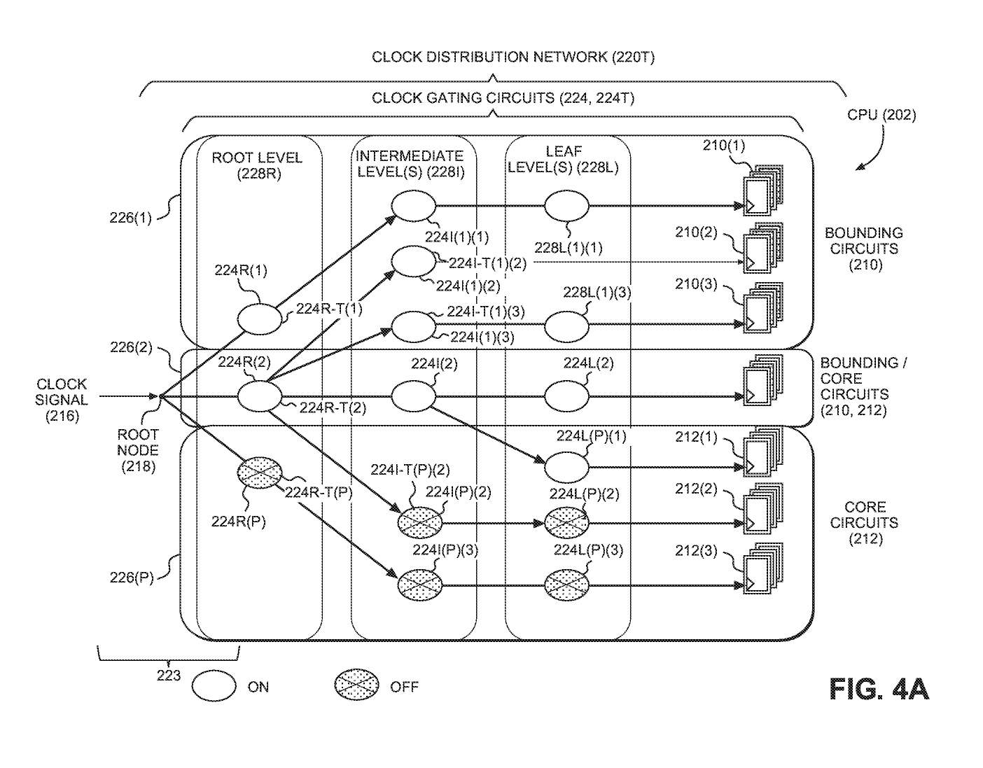

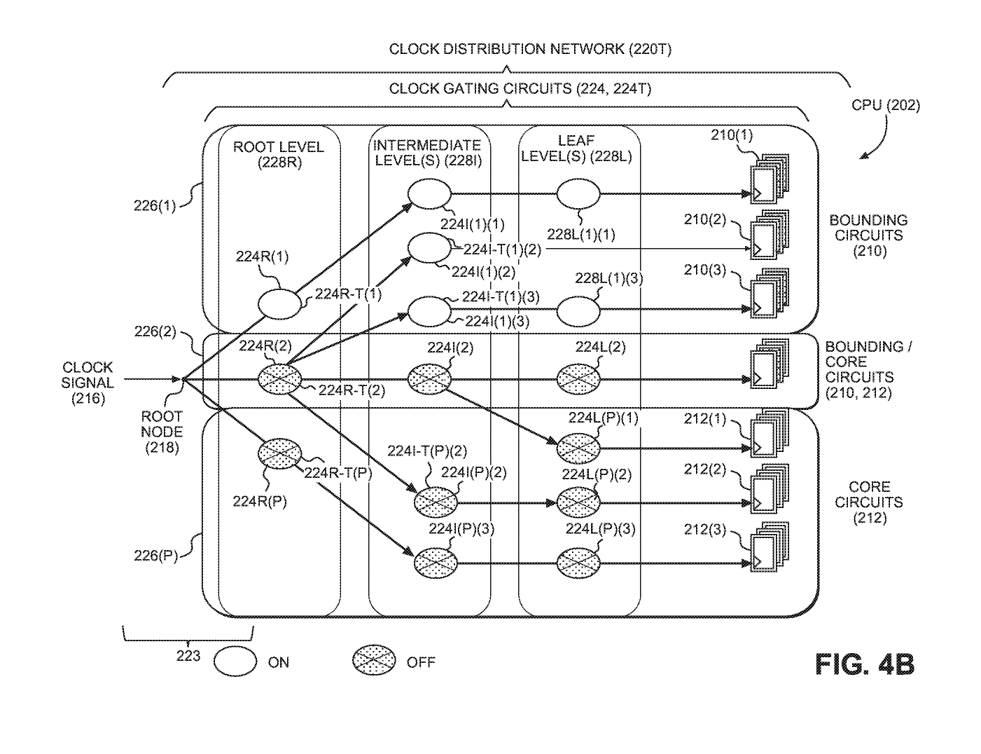

With continuing reference to FIG. 3, note that the intermediate functional clock gating circuit 224I(1)(2), 224I(1)(3), 224I(P)(2) in the intermediate level(s) 228I of the clock distribution network 220T are also segregated as intermediate test mode clock gating circuit 224I-T(1)(2), 224I-T(1)(3), 224I-T(P)(2) in this example. This allows further segregation of clock signal 216 distribution beyond the root level 228R for segregated functional and/or testing operation. For example, FIG. 4A illustrates a state of the clock distribution network 220T in a shift mode for the processor core 208 where the bounding circuits 210 need to be active to shift in logic states to the desired core circuits 212, 212(1) for processing. In this regard, as shown in FIG. 4A, all the functional clock gating circuits 224 in the bounding circuit clock distribution path 226(1) are clock gated active. The functional clock gating circuits 224 in the common circuit clock distribution path 226(2) are clock gated active or on, which will cause the common bounding and core circuits 210, 212 in the common circuit clock distribution path 226(2) to be active. This also causes the leaf functional clock gating circuit 224L(P)(1) to receive the clock signal 216 from the intermediate functional clock gating circuit 224I(2) such that core circuit 212(1) will be active. The root test mode clock gating circuit 224R-T(P)(2) can be controlled to be inactive or off, which will also cause the clock signal 216 to not be distributed to the intermediate functional clock gating circuit 224I(P)(2), 224I(P)(3) in the core circuit clock distribution path 226(P). However, to selectively also cause the intermediate and leaf functional clock gating circuit 224I(P)(2), 224L(P)(2) in the core circuit clock distribution path 226(P) to be inactive or off during shift mode, the intermediate functional clock gating circuit 224I(P)(2) is segregated as an intermediate test mode clock gating circuit 224I-T(P)(2).

FIG. 4B illustrates a state of the clock distribution network 220T in a capture mode for the processor core 208 where only the bounding circuits 210 in the bounding circuit clock distribution path 226(1) capture logic states to be provided to core circuit 212, 212(1)-212(3) in other modes. In this regard, as shown in FIG. 4B, all the functional clock gating circuits 224 in the bounding circuit clock distribution path 226(1) are clock gated active. The functional clock gating circuits 224 in the common circuit clock distribution path 226(2) are clock gated inactive or off. The root test mode clock gating circuit 224R-T(2) is disabled such that the clock signal 216 is not distributed to both the intermediate functional clock gating circuit 224I(2) and the intermediate functional clock gating circuit 224I(P)(2) and the leaf functional clock gating circuit 224L(P)(2) in the core circuit clock distribution path 226(P) so that core circuits 212(1), 212(2) are not active. The root test mode clock gating circuit 224R-T(P)(2) is also disabled such that the clock signal 216 is not distributed to the intermediate functional clock gating circuit 224I(P)(3) and leaf functional clock gating circuit 224L(P)(3).

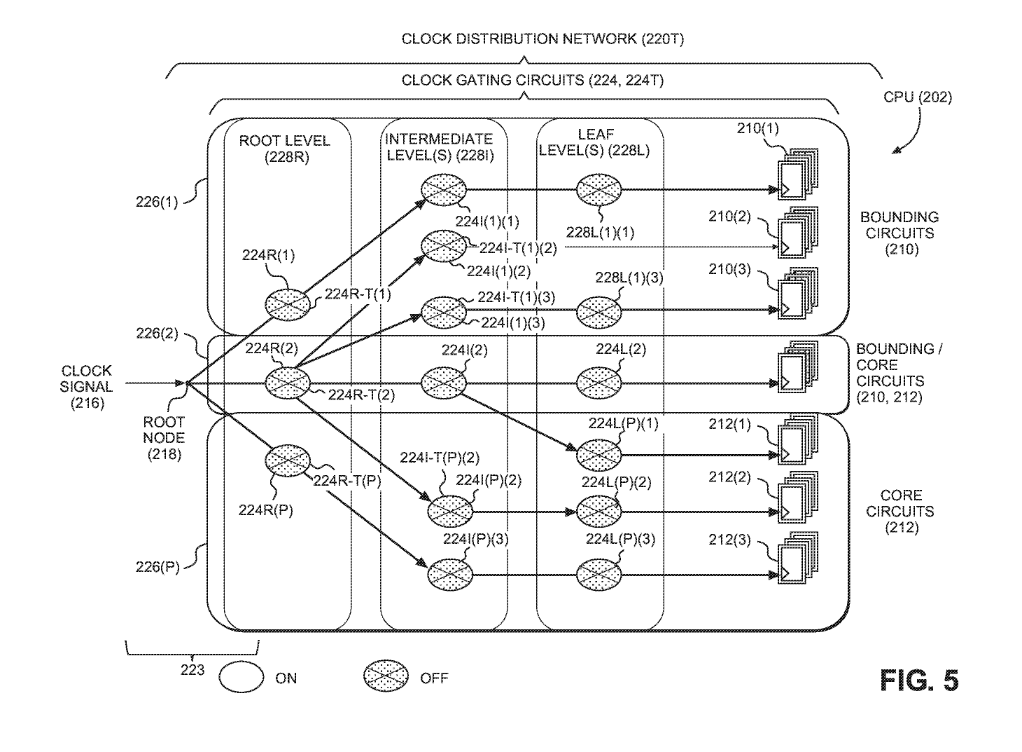

FIG. 5 illustrates a state of the clock distribution network 220T in a blockoff mode for the processor core 208 where it is desired for all the bounding circuits 210, 210(1)-210(3) and the core circuits 212, 212(1)-212(3) to not be active or on. In this regard, as shown in FIG. 5, the root test mode clock gating circuit 224R-T(1)-224R-T(3) are disabled such that the clock signal 216 is not distributed to any of the intermediate functional clock gating circuits 224I(1)(1)-224I(1)(3), 224I(2), 224I(P)(2)-224I(P)(3).

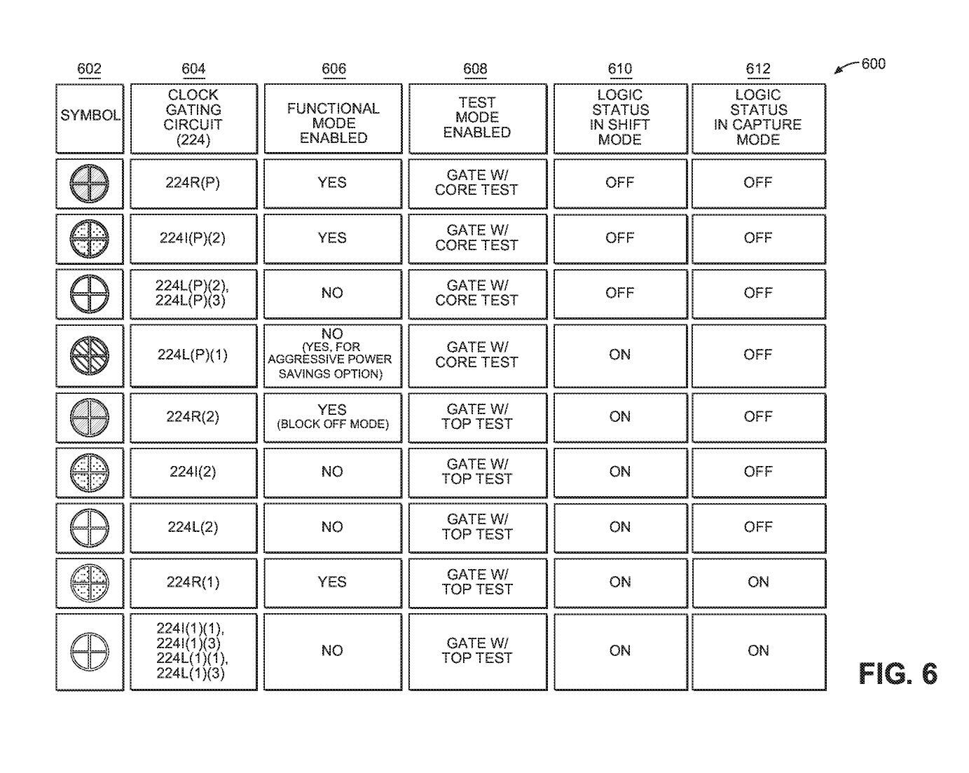

FIG. 6 is a table 600 illustrating exemplary functional and test mode clock gating scenarios of the functional clock gating circuits 224 that can be employed in the clock distribution network 220T in FIG. 3, and according to the shift and capture mode functions shown in FIGS. 4A and 4B. A list of the different symbols of functional clock gating circuits 224 in the clock distribution network 220T in FIG. 6 is provided in a first column 602. The different functional and test mode clock gating circuits 224 are provided in a second column 604. A third column 606 indicates if the functional and test mode clock gating circuits 224 are functional mode enabled, meaning that the functional or test mode clock gating circuits 224 can be enabled and disabled during a functional operational mode of the CPU 202 as desired. A fourth column 608 indicates if the functional and test mode clock gating circuits 224 are test mode enabled, meaning that the functional or test mode clock gating circuits 224 can be enabled and disabled during a test mode of the CPU 202 as desired. A fifth column 610 indicates whether the functional clock gating circuits 224 are active on, or inactive/off, during a shift test mode, as shown in FIG. 4A. A sixth column 612 indicates whether the functional or test clock gating circuits 224, 224T are active on, or inactive/off, during a capture test mode, as shown in FIG. 4B.

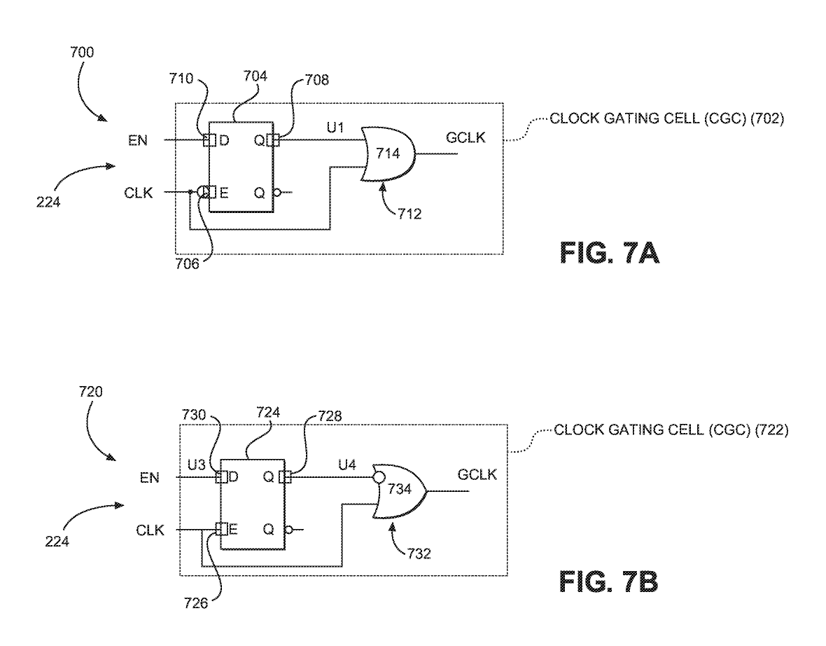

Different circuits can be employed to provide the functional clock gating circuits 224 described above. For example, FIG. 7A is a schematic diagram of an exemplary clock gating circuit 700 that can be used as a functional clock gating circuit 224. The clock gating circuit 700 is provided in the form of a functional mode clock gating cell (CGC) 702 that includes a negative edge-triggered latch to synchronize an enable signal EN to a clock signal CLK. As shown in FIG. 7A, the functional mode CGC 702 includes a flip-flop 704, which is a D flip-flop in this example. The flip-flop 704 includes a functional clock input 706 configured to receive the clock signal CLK. The flip-flop 704 also includes a functional clock output 708 configured to receive the clock signal CLK from the functional clock input 706. The flip-flop 704 also includes a functional clock enable input 710 configured to receive the clock enable signal EN indicating a functional mode as either a clock enable state or a clock disable state. The flip-flop 704 is configured to control distribution of the clock signal CLK from the functional clock input 706 to the functional clock output 708 based on the clock enable signal EN being in a clock enable state, which in this example is a logic high state or voltage level. An OR-based logic circuit 712 in the form of an OR gate 714 can be provided to distribute the clock signal CLK as an output clock signal GCLK synchronized with the clock enable signal EN on the negative edge of the clock signal CLK.

FIG. 7B is a schematic diagram of another exemplary clock gating circuit 720 that can be used as a functional clock gating circuit 224. The clock gating circuit 720 is provided in the form of a CGC 722 that includes a positive edge-triggered latch to synchronize an enable signal EN to a clock signal CLK. As shown in FIG. 7B, the CGC 722 includes a flip-flop 724, which is a D flip-flop in this example. The flip-flop 724 includes a functional clock input 726 configured to receive the clock signal CLK. The flip-flop 724 also includes a functional clock output 728 configured to receive the clock signal CLK from the functional clock input 726. The flip-flop 724 also includes a functional clock enable input 730 configured to receive the clock enable signal EN indicating a functional mode as either a clock enable state or a clock disable state. The flip-flop 724 is configured to control distribution of the clock signal CLK from the functional clock input 726 to the functional clock output 728 based on the clock enable signal EN being in a clock enable state, which in this example is a logic high state or voltage level. An OR-based logic circuit 732 in the form of an OR gate 734 can be provided to distribute the clock signal CLK as an output clock signal GCLK synchronized with the clock enable signal EN on the positive edge of the clock signal CLK.

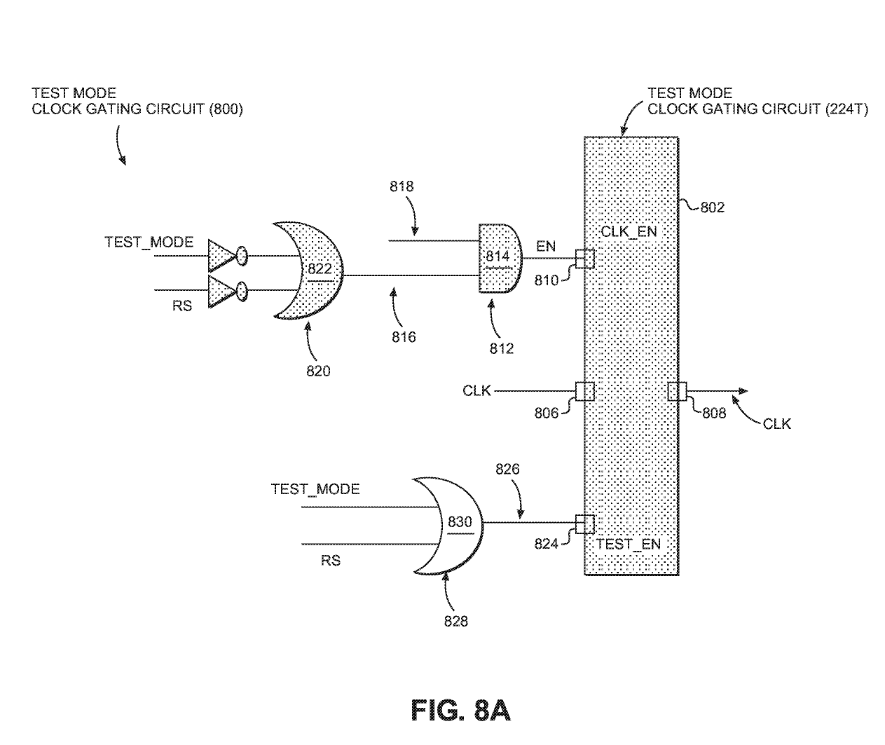

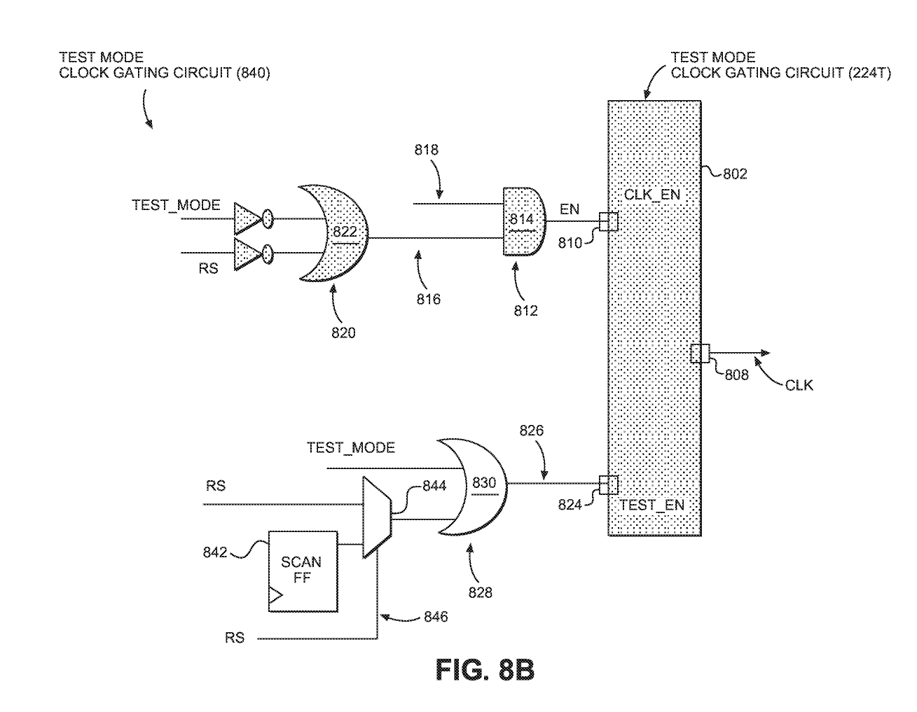

Different circuits can be employed to provide the test mode clock gating circuits 224T described above. For example, FIG. 8A is a schematic diagram of an exemplary test mode clock gating circuit 800 that can be used as a test mode clock gating circuit 224T. The test mode clock gating circuit 800 is provided in the form of a test mode CGC 802. The test mode CGC 802 can be configured to be functionally clock enabled during a functional mode and test mode clock enabled during a test mode. As shown in FIG. 8A, the test mode CGC 802 includes a test clock input 806 configured to receive the clock signal CLK. The test mode CGC 802 also includes a test clock output 808 configured to receive the clock signal CLK from the test clock input 806. The test mode CGC 802 also includes a functional clock enable input 810 configured to receive a clock enable signal EN indicating a functional mode as either a clock enable state or a clock disable state. The test mode CGC 802 is configured to control distribution of the clock signal CLK from the test clock input 806 to the test clock output 808 based on the clock enable signal EN being in a clock enable state. The test clock output 808 does not receive the clock signal CLK for distribution in response to a functional mode disable state and the test mode enable state is not enabled. The test clock output 808 receives the clock signal CLK for distribution in response to a functional mode enable state if the test mode enable state is enabled.

To allow the functional clock enable input 810 of the test mode CGC 802 to be disabled during a test mode, an AND-based logic circuit 812 in the form of an AND gate 814 in this example is configured to receive a first output signal 816 and a functional clock enable signal 818 indicating a functional enable state. The AND-based logic circuit 812 is configured to generate the clock enable signal EN based on an AND-based logic operation of the first output signal 816 and the functional clock enable signal 818. The first output signal 816 is generated by an OR-based logic circuit 820 in the form of an OR gate 822 in this example. The OR-based logic circuit 820 is configured to receive a test mode signal TEST_MODE and a register signal RS, which is from a programmable register or a configuration register, and generate the first output signal 816 based on an OR-based logic operation of the test mode signal TEST_MODE and the register signal RS. For example, the register signal RS may be a signal as part of an ATPG signal that represents a state or pattern stored in a programmable register or a configuration register so that the test mode CGC 802 can be selectively clock enabled and disabled based on a functional mode pattern, if desired. For example, the register signal RS may be a JTAG data register (JDR) signal from a JTAG data register. With continuing reference to FIG. 8A, the test mode CGC 802 is also configured to be test mode clock enabled and disabled in addition to functional mode clock enabled and disabled. In this regard, the test mode CGC 802 also includes a test mode enable input 824 configured to receive a test mode enable signal. The test mode CGC 802 is configured to control distribution of the clock signal CLK to the test clock output 808 based on the test mode enable signal 826 being in a test mode enable state or a test mode disable state. The test clock output 808 does not receive the clock signal CLK for distribution in response to a test mode disable state. The test clock output 808 receives the clock signal CLK for distribution in response to a test mode enable state. The test mode enable signal 826 is generated by an OR-based logic circuit 828 in the form of an OR gate 830 in this example The OR-based logic circuit 828 is configured to receive a test mode signal TEST_MODE and a register signal RS, and generate the test mode enable signal 826 based on an OR-based logic operation of the test mode signal TEST_MODE and the register signal RS. For example, the register signal RS may be a signal from a configurable or programmable register as part of an ATPG signal so that the test mode CGC 802 can be selectively clock enabled and disabled based on a test mode pattern, if desired.

FIG. 8B is a schematic diagram of another exemplary test mode clock gating circuit 840 that can be used as a test mode clock gating circuit 224T. The test mode clock gating circuit 840 contains the same test mode CGC 802 as the test mode clock gating circuit 800 in FIG. 8A as well as other common components shown with common element numbers between FIGS. 8A and 8B, which will thus not be re-described. The test mode clock gating circuit 840 in FIG. 8B has the additional functionality to control the test mode enable signal 826 based on the register signal RS or a stored value in a scan flip-flop 842. A control circuit 844 is provided to control whether the register signal RS or the test mode signal TEST_MODE is based on a control input signal 846, which is the register signal RS in this example. For example, it may be desired to employ a test pattern for controlling the test mode enable signal 826. By providing the scan flip-flip 842, a test pattern value can be latched and stored to allow for a granular enabling of the test mode CGC 802. For example, the scan flip-flop 842 could be added to the root and intermediate functional clock gating circuits 224R, 224I. Low toggle patterns can be generated by gating the functional clock enable input 810 off and the test mode enable input 824 on with dynamic scan flip-flop 842-based control. Pattern inflation maybe be limited for low toggle patterns since this circuit configuration allows controlling the test mode CGC 802 using the test mode enable input 824 with more complex logic to enable and disable the functional clock enable input 810. Disabling the clock signal CLK for low toggle patterns can mitigate or reduce local IR-drop during test modes.

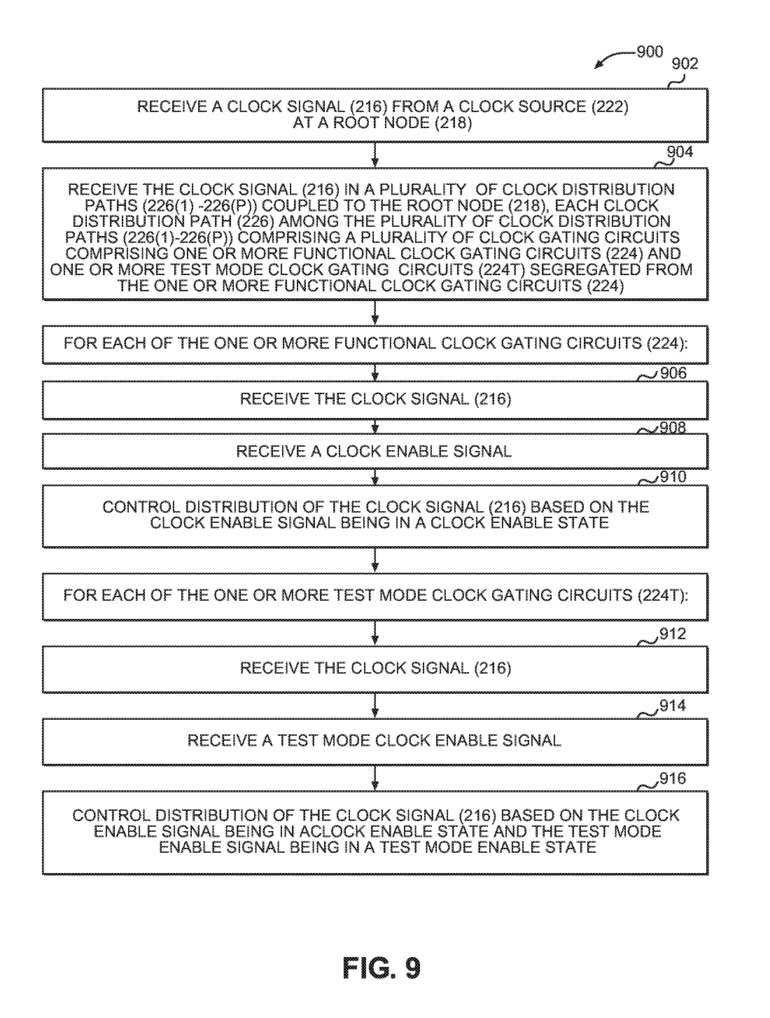

FIG. 9 is a flowchart illustrating an exemplary process 900 of test mode clock gating segregated test mode clock gating circuits 224T in a circuit, such as the CPU 202 in FIGS. 2A and 3A for example, to provide for hierarchical testing of circuit blocks in the circuit. In this regard, and using the CPU 202 in FIGS. 2A and 3A as an example, the process 900 comprises receiving a clock signal 216 from a clock source 222 at a root node 218 (block 902). The process 900 also comprises receiving the clock signal 216 in a plurality of clock distribution paths 226(1)-226(P) coupled to the root node 218, each clock distribution path 226 among the plurality of clock distribution paths 226(1)-226(P) comprising a plurality of clock gating circuits comprising one or more functional clock gating circuits 224 and one or more test mode clock gating circuits 224T segregated from the one or more functional clock gating circuits 224 (block 904). The process 900 also comprises, for each of the one or more functional clock gating circuits 224, receiving the clock signal 216 (block 906), and receiving a clock enable signal (block 908), and controlling distribution of the clock signal 216 based on the clock enable signal being in a clock enable state (block 910). The process 900 also comprises, for each of the one or more test mode clock gating circuits 224T, receiving the clock signal 216 (block 912), receiving a test mode clock enable signal (block 914), and controlling distribution of the clock signal 216 based on the clock enable signal being in a clock enable state and the test mode enable signal being in a test mode enable state (block 916).

A processor-based system that includes a CPU that includes one or more processor cores, such as the CPU 202 in FIGS. 2A and 2B as a non-limiting example, and includes a clock distribution network that includes segregated test mode clock gating circuits for selectively controlling clock signal distribution to circuit blocks during testing functional clock gating circuit blocks in the one or more processor cores, including but not limited to the clock distribution network 220 in FIGS. 2A and 2B as a non-limiting example, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

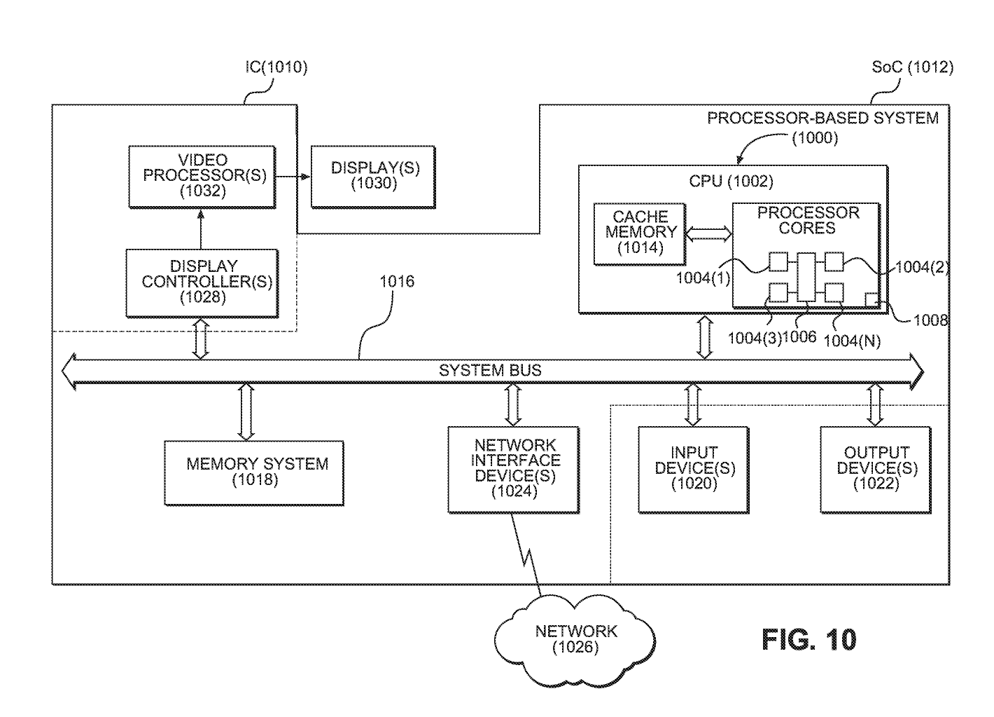

FIG. 10 illustrates an example of a processor-based system 1000 that includes a CPU 1002, such as the CPU 202 in FIGS. 2A and 2B as a non-limiting example, and includes one or more processor cores 1004(1)-1004(N). The CPU 1002 may include a parent processor core 1006 wherein the one or more processor cores 1004(1)-1004(N) are child processor cores. The processor cores 1004(1)-1004(N), 1006 can include a clock distribution network 1008, such as the clock distribution network 220 in FIGS. 2A and 2B as a non-limiting example, that includes segregated test mode clock gating circuits for selectively controlling clock signal distribution to circuit blocks during testing of functional clock gating circuit blocks in the one or more processor cores 1004(1)-1004(N), 1006.

In this example, the processor-based system 1000 is provided in an IC 1010. The IC 1010 may be included in or provided as a SoC 1012 as an example. The CPU 1002 may have a cache memory 1014 coupled to the processor cores 1004(1)-1004(N) for rapid access to temporarily stored data. The CPU 1002 is coupled to a system bus 1016 and can intercouple master and slave devices included in the processor-based system 1000. As is well known, the CPU 1002 communicates with these other devices by exchanging address, control, and data information over the system bus 1016. Although not illustrated in FIG. 10, multiple system buses 1016 could be provided, wherein each system bus 1016 constitutes a different fabric. For example, the CPU 1002 can communicate bus transaction requests to a memory system 1018 as an example of a slave device.

Other master and slave devices can be connected to the system bus 1016. As illustrated in FIG. 10, these devices can include the memory system 1018 and one or more input devices 1020. The input device(s) 1020 can include any type of input device, including but not limited to input keys, switches, voice processors, etc. The input device(s) 1020 may be included in the IC 1010 or external to the IC 1010, or a combination of both. Other devices that can be connected to the system bus 1016 can also include one or more output devices 1022, and one or more network interface devices 1024. The output device(s) 1022 can include any type of output device, including but not limited to audio, video, other visual indicators, etc. The output device(s) 1020 may be included in the IC 1010 or external to the IC 1010, or a combination of both. The network interface device(s) 1024 can be any devices configured to allow exchange of data to and from a network 1026. The network 1026 can be any type of network, including but not limited to a wired or wireless network, a private or public network, a local area network (LAN), a wireless local area network (WLAN), a wide area network (WAN), a BLUETOOTH™ network, and the Internet. The network interface device(s) 1024 can be configured to support any type of communications protocol desired.

Other devices that can be connected to the system bus 1016 can also include one or more display controllers 1028 as examples. The CPU 1002 may be configured to access the display controller(s) 1028 over the system bus 1016 to control information sent to one or more displays 1030. The display controller(s) 1028 can send information to the display(s) 1030 to be displayed via one or more video processors 1032, which process the information to be displayed into a format suitable for the display(s) 1030. The display controller(s) 1028 and/or the video processor(s) 1032 may be included in the IC 1010 or external to the IC 1010, or a combination of both.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A clock distribution network for distributing a clock signal to circuit blocks in a circuit, the clock distribution network comprising:
a root node configured to receive a clock signal from a clock source; and
a plurality of clock distribution paths coupled to the root node, each clock distribution path among the plurality of clock distribution paths configured to receive the clock signal;
each clock distribution path among the plurality of clock distribution paths comprising a plurality of clock gating circuits, the plurality of clock gating circuits comprising:
one or more functional clock gating circuits, each functional clock gating circuit among the one or more functional clock gating circuits comprising:
a functional clock input configured to receive the clock signal;
a functional clock output configured to receive the clock signal from the functional clock input; and
a functional clock enable input configured to receive a clock enable signal;
the functional clock gating circuit configured to control distribution of the clock signal from the functional clock input to the functional clock output based on the clock enable signal being in a clock enable state; and
one or more test mode clock gating circuits segregated from the one or more functional clock gating circuits, each test mode clock gating circuit among the one or more test mode clock gating circuits comprising:
a test clock input configured to receive the clock signal;
a test clock output configured to receive the clock signal from the test clock input; and
a test mode clock enable input configured to receive a test mode enable signal;
the test mode clock gating circuit configured to control distribution of the clock signal from the test clock input to the test clock output based on the clock enable signal being in the clock enable state and the test mode enable signal being in a test mode enable state.

2. The clock distribution network of claim 1, wherein each clock distribution path among the plurality of clock distribution paths comprises:
one or more root clock distribution paths each configured to receive the clock signal and distribute a clock signal based on the received clock signal; and
a plurality of leaf clock distribution paths coupled to each of the one or more root clock distribution paths, the plurality of leaf clock distribution paths configured to receive the clock signal from the root clock distribution path and distribute a clock signal based on the received clock signal.

3. The clock distribution network of claim 2, wherein each leaf clock distribution path among the plurality of leaf clock distribution paths is configured to distribute the clock signal to a synchronous circuit block.

4. The clock distribution network of claim 2, wherein:
at least one of the one or more root clock distribution paths comprises at least one test mode clock gating circuit among the one or more test mode clock gating circuits; and
at least one of the plurality of leaf clock distribution paths coupled to the at least one of the one or more root clock distribution paths comprises at least one functional clock gating circuit among the one or more functional clock gating circuits.

5. The clock distribution network of claim 2, wherein:
at least one of the one or more root clock distribution paths comprises at least one functional clock gating circuit among the one or more functional clock gating circuits; and
at least one of the plurality of leaf clock distribution paths coupled to the at least one of the one or more root clock distribution paths comprises at least one test mode clock gating circuit among the one or more test mode clock gating circuits.

6. The clock distribution network of claim 1, wherein:
the one or more functional clock gating circuits comprises one or more functional clock gating cells (CGCs); and
the one or more test mode clock gating circuits comprises one or more test mode CGCs.

7. The clock distribution network of claim 6, wherein each of the one or more functional CGCs comprises a flip-flop comprising:
the functional clock input configured to receive the clock signal;
the functional clock output configured to receive the clock signal from the functional clock input; and
the functional clock enable input configured to receive the clock enable signal;
the flip-flop configured to control distribution of the clock signal from the functional clock input to the functional clock output based on the clock enable signal being in the clock enable state.

8. The clock distribution network of claim 7, wherein, each of the one or more test mode CGCs comprises a flip-flop comprising:
the test clock input configured to receive the clock signal;
the test clock output configured to receive the clock signal from the test clock input; and
the test mode clock enable input configured to receive the test mode enable signal;
the flip-flop configured to control distribution of the clock signal from the test clock input to the test clock output based on the clock enable signal being in the clock enable state and the test mode enable signal being in the test mode enable state.

9. The clock distribution network of claim 1, further comprising a block clock gating circuit coupled between the root node and the plurality of clock distribution paths, the block clock gating circuit configured to control distribution of the clock signal from a clock input to a clock output based on an enable signal being in an enable state.

10. The clock distribution network of claim 9, wherein the block clock gating circuit comprises:
the clock input configured to receive the clock signal from the root node;
the clock output configured to receive the clock signal from the clock input; and
an enable input configured to receive the enable signal;
the block clock gating circuit configured to control distribution of the clock signal from the clock input to the clock output based on the enable signal being in the enable state.

11. The clock distribution network of claim 1, wherein each test mode clock gating circuit among the one or more test mode clock gating circuits is further configured to:
generate the clock enable signal based on a functional clock enable signal indicating a functional enable state and the test mode enable signal indicating the test mode enable state; and
generate the test mode enable signal based on a test mode signal.

12. The clock distribution network of claim 11, wherein a test mode enable circuit is configured to generate the test mode enable signal based on the test mode signal and a register signal.

13. The clock distribution network of claim 11, wherein each test mode clock gating circuit among the one or more test mode clock gating circuits comprises:
an OR-based logic circuit configured to receive the test mode enable signal and a register signal and generate a first output signal based on an OR-based logic operation of the test mode enable signal and the register signal; and
an AND-based logic circuit configured to receive the first output signal and the functional clock enable signal indicating the functional enable state, and generate the clock enable signal based on an AND-based logic operation of the first output signal and the functional clock enable signal.

14. The clock distribution network of claim 11, further comprising a test mode enable circuit comprising an OR-based logic circuit configured to receive the test mode signal and a register signal, and generate the test mode enable signal based on an OR-based logic operation of the test mode signal and the register signal.

15. The clock distribution network of claim 14, wherein each test mode clock gating circuit among the one or more test mode clock gating circuits further comprises:
a scan flip-flop configured to latch a pattern value; and
a control circuit configured to receive the register signal, the pattern value, and a control input signal, and generate the test mode signal as either the register signal or the pattern value based on the control input signal.

16. The clock distribution network of claim 1 integrated into an integrated circuit (IC).

17. The clock distribution network of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

18. A clock distribution network for distributing a clock signal to circuit blocks in a circuit, the clock distribution network comprising:
a means for receiving a clock signal from a clock source; and
a plurality of means for distributing the clock signal coupled to the means for receiving the clock signal from the clock source, each of the plurality of means for distributing the clock signal configured to receive the clock signal;
each means for distributing the clock signal among the plurality of means for distributing the clock signal comprising a plurality of means for gating the clock signal comprising:
one or more means for functionally gating the clock signal each comprising:
a functional clock input means for receiving the clock signal;
a functional clock output means for receiving the clock signal from the functional clock input means;
a means for receiving a clock enable signal; and
a means for controlling distribution of the clock signal from the functional clock input means to the functional clock output means based on the clock enable signal being in a clock enable state; and
one or more means for test mode clock gating the clock signal segregated from the one or more means for functionally clock gating the clock signal, the one or more means for test mode clock gating the clock signal each comprising:
a test clock input means for receiving the clock signal;
a test clock output means for receiving the clock signal from the test clock input means;
a means for receiving the clock enable signal;
a means for receiving a test mode enable signal; and
a means for controlling distribution of the clock signal from the test clock input means to the test clock output means based on the clock enable signal being in the clock enable state and the test mode enable signal being in a test mode enable state.

19. A method of testing a circuit, comprising:
receiving a clock signal from a clock source at a root node;
receiving the clock signal in a plurality of clock distribution paths coupled to the root node, each clock distribution path among the plurality of clock distribution paths comprising a plurality of clock gating circuits comprising one or more functional clock gating circuits and one or more test mode clock gating circuits segregated from the one or more functional clock gating circuits;
for each of the one or more functional clock gating circuits:
receiving the clock signal;
receiving a clock enable signal;
controlling distribution of the clock signal based on the clock enable signal being in a clock enable state; and
for each of the one or more test mode clock gating circuits:
receiving the clock signal;
receiving the clock enable signal;
receiving a test mode enable signal; and
controlling distribution of the clock signal based on the clock enable signal being in the clock enable state and the test mode enable signal being in a test mode enable state.

20. The method of claim 19, further comprising, for each test mode clock gating circuit:
generating the clock enable signal based on a functional clock enable signal indicating a functional enable state and the test mode enable signal indicating the test mode enable state; and
generating the test mode enable signal based on a test mode signal.

21. The method of claim 20, further comprising, for each test mode clock gating circuit, generating the test mode enable signal based on the test mode signal and a register signal.

22. The method of claim 20, further comprising, for each functional clock gating circuit:
receiving the test mode enable signal;
receiving a register signal;
generating a first output signal based on an OR-based logic operation of the test mode enable signal and the register signal; and
receiving a first output signal;
receiving the functional clock enable signal indicating a functional enable state; and
generating the clock enable signal based on an AND-based logic operation of the first output signal and the functional clock enable signal.

23. The method of claim 20, further comprising, for each test mode clock gating circuit:
receiving the test mode enable signal;
receiving the register signal; and
generating the test mode enable signal based on an OR-based logic operation of the test mode signal and the register signal.

24. A central processing system (CPU), comprising:
a clock distribution network, comprising:
a root node configured to receive a clock signal from a clock source;
at least one bounding circuit clock distribution path coupled to the root node and configured to receive the clock signal and distribute the clock signal to at least one bounding circuit;
at least one core circuit clock distribution path coupled to the root node and configured to receive the clock signal and distribute the clock signal to at least one core circuit; and
a plurality of clock gating circuits comprising one or more functional clock gating circuits and one or more test mode clock gating circuits segregated from the one or more functional clock gating circuits;
the at least one bounding circuit clock distribution path comprising one or more functional clock gating circuits and one or more test mode clock gating circuits segregated from the one or more functional clock gating circuits;
the at least one core circuit clock distribution path comprising one or more functional clock gating circuits and one or more test mode clock gating circuits segregated from the one or more functional clock gating circuits;
each functional clock gating circuit among the one or more functional clock gating circuits comprising:
a functional clock input configured to receive the clock signal;
a functional clock output configured to receive the clock signal from the functional clock input; and
a functional clock enable input configured to receive a clock enable signal;
the functional clock gating circuit configured to control distribution of the clock signal from the functional clock input to the functional clock output based on the clock enable signal being in a clock enable state; and
each test mode clock gating circuit of the one or more test mode clock gating circuits segregated from the one or more functional clock gating circuits comprising:
a test clock input configured to receive the clock signal;
a test clock output configured to receive the clock signal from the test clock input; and
a test mode clock enable input configured to receive a test mode enable signal; and
the test mode clock gating circuit configured to control distribution of the clock signal from the test clock input to the test clock output based on the clock enable signal being in the clock enable state and the test mode enable signal being in a test mode enable state; and
a plurality of processor cores, each processor core among the plurality of processor cores comprising:
one or more core circuits configured to receive the clock signal from the at least one core circuit clock distribution path and perform synchronous operations in response to the clock signal; and
one or more bounding circuits interfaced to the core circuit block, the bounding circuit configured to receive the clock signal from the at least one bounding circuit clock distribution path and perform synchronous operations in response to the clock signal.

25. The CPU of claim 24, further comprising at least one common circuit clock distribution path coupled to the root node and configured receive the clock signal and distribute the clock signal; and
wherein:
each processor core among the plurality of processor cores further comprises at least one of a core circuit and a bounding circuit configured to receive the clock signal from the at least one core circuit clock distribution path and perform synchronous operations in response to the clock signal; and
the at least one common circuit clock distribution path comprising one or more functional clock gating circuits and one or more test mode clock gating circuits segregated from the one or more functional clock gating circuits.

25. The CPU of claim 24, further comprising at least one common logic clock distribution path coupled to the root node and configured to receive the clock signal and distribute the clock signal; and
wherein:
each processor core among the plurality of processor cores further comprises a common logic circuit block comprising one or more common circuits configured to receive the clock signal from the at least one core circuit clock distribution path and perform synchronous operations in response to the clock signal; and
the at least one common logic clock distribution path comprising one or more functional clock gating circuits and one or more test mode clock gating circuits segregated from the one or more functional clock gating circuits.

26. The CPU of claim 24, wherein:
the one or more test mode clock gating circuits in the bounding circuit clock distribution path are located closer to the root node than the one or more functional clock gating circuits in the bounding circuit clock distribution path; and
the one or more test mode clock gating circuits in the core circuit clock distribution path are located closer to the root node than the one or more functional clock gating circuits in the core circuit clock distribution path.

27. The CPU of claim 24, wherein each test mode clock gating circuit among the one or more test mode clock gating circuits is further configured to:
generate the clock enable signal based on a functional clock enable signal indicating a functional enable state and the test mode enable signal indicating the test mode enable state; and
generate the test mode enable signal based on a test mode signal.

28. The CPU of claim 27, wherein a test mode enable circuit is configured to generate the test mode enable signal based on the test mode signal and a register signal.

29. The CPU of claim 27, each test mode clock gating circuit among the one or more test mode clock gating circuits further comprises:
an OR-based logic circuit configured to receive the test mode enable signal and a register signal and generate a first output signal based on an OR-based logic operation of the test mode enable signal and the register signal; and
an AND-based logic circuit configured to receive the first output signal and the functional clock enable signal indicating the functional enable state, and generate the clock enable signal based on an AND-based logic operation of the first output signal and the functional clock enable signal.

30. The CPU of claim 27, further comprising a test mode enable circuit comprising an OR-based logic circuit configured to receive the test mode signal and a register signal, and generate the test mode enable signal based on an OR-based logic operation of the test mode signal and the register signal.
